(19) United States
(12) Patent Application Publication
(10) Pub. No.: US 2005/0150514 A1
(43) Pub. Date: Jul. 14, 2005

(54) Device for cleaning tooth and gum surfaces

(75) Inventor: Jeffrey Gabbay, Jerusalem (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Cupron Corporation, New York, NY (US)

(21) Appl. No.: 11/066,893

(22) Filed: Feb. 25, 2005

Related U.S. Application Data
(63) Continuation-in-part of application No. 10/890,936, filed on Jul. 13, 2004.
Application No. 10/890,936 is a continuation-in-part of application No. 10/240,993, filed on Dec. 16, 2002.

(30) Foreign Application Priority Data
Apr. 5, 2000 (IL) 135,487

(51) Int. Cl. C11D 17/00

(52) U.S. Cl. 132/321

(57) ABSTRACT

The invention provides, a device for cleaning tooth and gum surfaces the device having incorporated therein an antimicrobial polymeric material formed from a polymeric component, the material being in the form of a bristle or yam, and comprising an antimicrobial agent consisting essentially of discreet, microscopic, Cu⁺⁺ releasing water insoluble particles, embedded directly in the component, with a portion of the particles being exposed and protruding from surfaces thereof, which particles release Cu⁺⁺ ions, upon contact with a fluid.

### CROSS-REFERENCES TO RELATED APPLICATIONS

This application is a continuation-in-part of copending U.S. application Ser. No. 10/890,936, filed Jul. 13, 2004, which in turn is a continuation-in-part of U.S. application Ser. No. 10/240,993, filed Apr. 1, 2001, which is a U.S. national phase of PCT/IL01/00299, filed Apr. 1, 2001, which claims the benefit under 35 USC 119(a) of IL135,487, filed Apr. 5, 2000.

### BACKGROUND OF THE INVENTION

The present invention relates to a device for cleaning tooth and gum surfaces. More particularly, the present invention relates to a device for cleaning tooth and gum surfaces incorporating an antimicrobial polymeric material.

According to the invention described in said above-mentioned applications, it was discovered that by adding a small percentage of Cu++ in the form of water insoluble copper oxide particles to the slurry of a polymer to be formed into a wrapping material, the package is rendered antimicrobial.

Furthermore it was surprisingly discovered that by adding copper oxide in particle form into a polymeric slurry of such polymers as polyethylene, polypropylene, polyesters and similar hydrophobic polymeric materials it is possible to extrude fibers, yarns or sheets which possess both antimicrobial and antiviral properties which have a multiplicity of uses. Among the uses contemplated for the novel antimicrobial and antiviral polymeric materials of said invention is their use in a backing for a carpet, which could even be used in a hospital setting since it would not develop mold, smell, and would inactivate any viruses settling thereon; the use as a component of a molded non-woven product such as an air filter in a hospital or airplane or a mask which could be made air permeable or liquid permeable and be used to filter fluids flowing there through and to inactivate bacteria and viruses found in said fluids; formation into a continuous, flat, textured or stretched form which could be used in articles of clothing such as stockings, socks, shirts or any article of clothing that would incorporate a hydrophobic polymeric fiber or yam; formation of a short staple fiber which could be then used as is or blended with other fibers such as cotton, which blended yarns could then be used for the manufacture of a variety of both knit and woven products such as socks, sheets, etc.; and use of such polymeric materials, manufactured in the form of a bi-component yam in which the core is one compound and the sheath around the core is a polymer containing the water insoluble copper oxide particles creating a yarn with a multitude of end uses in either a continuous, flat, textured, stretched form or as a short staple. An example of said latter use would be the use of a polyethylene core or even a stainless steel core with a polymeric sheath incorporating said water insoluble copper oxide particles to form a yarn with an increased resistance to being cut or ripped while also being both antimicrobial and antiviral and having a multiplicity of uses including in the food preparation industry.

Said earlier applications however, did not teach or suggest the use of polymeric materials comprising an antimicrobial agent consisting essentially of microscopic Cu⁺⁺ releasing water insoluble particles, embedded directly in said polymeric material, with a portion of said particles being exposed and protruding from surfaces thereof, which particles release Cu⁺⁺ ions, upon contact with a fluid. in a device for the reduction of oral bacteria.

In both WO 98/06508 and WO 98/06509 there are taught various aspects of a textile with a full or partial metal or metal oxide plating directly and securely bonded to the fibers thereof, wherein metal and metal oxides, including copper, are bonded to said fibers.

More specifically, in WO 98/06509 there is provided a process comprising the steps of: (a) providing a metallized textile, the metallized textile comprising: (i) a textile including fibers selected from the group consisting of natural fibers, synthetic cellulosic fibers, regenerated fibers, acrylic fibers, polyolefin fibers, polyurethane fibers, vinyl fibers, and blends thereof, and (ii) a plating including materials selected from the group consisting of metals and metal oxides, the metallized textile characterized in that the plating is bonded directly to the fibers; and (b) incorporating the metallized textile in an article of manufacture.

In the context of said invention the term “textile” includes fibers, whether natural (for example, cotton, silk, wool, and linen) or synthetic yarns spun from those fibers, and woven, knit, and non-woven fabrics made of those yarns. The scope of said invention includes all natural fibers; and all synthetic fibers used in textile applications, including but not limited to synthetic cellulosic fibers (i.e., regenerated cellulose fibers such as rayon, and cellulose derivative fibers such as acetate fibers), regenerated protein fibers, acrylic fibers, polyolefin fibers, polyurethane fibers, and vinyl fibers, but excluding nylon and polyester fibers, and blends thereof.

Said invention comprised application to the products of an adaptation of boards made of plastic, with metals. See, for example, Encyclopedia of Polymer Science and Engineering (Jacqueline I. Kroschwitz, editor), Wiley and Sons, 1987, vol. IX, pp 580-598. As applied to textiles, this process included two steps. The first step was the activation of the textile by precipitating catalytic noble metal nucleation sites on the textile. This was done by first soaking the textile in a solution of a low-oxidation-state reductant cation, and then soaking the textile in a solution of noble metal cations, preferably a solution of Pd++ cations, most preferably an acidic PdCl₂ solution. The low-oxidation-state cation reduces the noble metal cations to the noble metals themselves, while being oxidized to a higher oxidation state. Preferably, the reductant cation is one that is soluble in both the initial low oxidation state and the final high oxidation state, for example Sn++, which is oxidized to Sn++++, or Ti+++, which is oxidized to T++++.

The second step was the reduction, in close proximity to the activated textile, of a metal cation whose reduction was catalyzed by a noble metal. The reducing agents used to reduce the cations typically were molecular species, for example, formaldehyde in the case of Cu++. Because the reducing agents were oxidized, the metal cations are termed “oxidant cations” herein. The metallized textiles thus produced were characterized in that their metal plating was bonded directly to the textile fibers.

In WO 98/06508 there is described and claimed a composition of matter comprising:
(a) a textile including fibers selected from the group consisting of natural fibers, synthetic cellulosic fibers, regenerated protein fibers, acrylic fibers, polyolefin fibers, polyurethane fibers, vinyl fibers, and blends thereof; and
(b) a plating including materials selected from the group consisting of metals and metal oxides;
   the composition of matter characterized in that said plating is bonded directly to said fibers.

Said publication also claims a composition of matter comprising:
(a) a textile including fibers selected from the group consisting of natural fibers, synthetic cellulosic fibers, regenerated protein fibers, acrylic fibers, polyolefin fibers, polyurethane fibers, vinyl fibers, and blends thereof; and
(b) a plurality of nucleation sites, each of said nucleation sites including at least one noble metal;
the composition of matter characterized by catalyzing the reduction of at least one metallic cationic species to a reduced metal, thereby plating said fibers with said reduced metal.

In addition, said publication teaches and claims processes for producing said products.

A preferred process for preparing a metallized textile according to said publication comprises the steps of:
a) selecting a textile, in a form selected from the group consisting of yam and fabric, said textile including fibers selected from the group consisting of natural fibers, synthetic cellulosic fibers, regenerated protein fibers, acrylic fibers, polyolefin fibers, polyurethane fibers, vinyl fibers, and blends thereof;
b) soaking said textile in a solution containing at least one reductant cationic species having at least two positive oxidation states, said at least one cationic species being in a lower of said at least two positive oxidation states;
c) soaking said textile in a solution containing at least one noble metal cationic species, thereby producing an activated textile; and
d) reducing at least one oxidant cationic species in a medium in contact with said activated textile, thereby producing a metallized textile.

Said publications, however, are limited to coated fibers and textiles prepared according to said processes and do not teach or suggest the possibility of incorporating cationic copper into a polymeric slurry of a hydrophobic polymer whereby there are produced films and fibers having microscopic particles of cationic copper encapsulated therein and protruding therefrom and having antimicrobial and antiviral polymeric properties, as described and exemplified herein.

With this state of the art in mind there is now provided according to the present invention a device for cleaning tooth and gum surfaces said device having incorporated therein an antimicrobial polymeric material formed from a polymeric component, said material being in the form of a bristle or yarn, and comprising an antimicrobial agent consisting essentially of microscopic Cu⁺⁺ releasing water insoluble particles, embedded directly in said component, with a portion of said particles being exposed and protruding from surfaces thereof, which particles release Cu⁺⁺ ions, upon contact with a fluid.

In preferred embodiments of the present invention said polymeric material has incorporated therein exposed Cu⁺⁺ releasing water insoluble copper oxide particles which protrude from the polymeric material.

In especially preferred embodiments of the present invention said polymeric material has incorporated therein a mixture of particles of CuO and Cu₂O which particles release combinations of Cu⁺⁺ and Cu⁺ upon contact with a fluid.

Preferrably said particles are of a size of between 1 and 10 microns.

In preferred embodiments of the present invention said particles are present in an amount of between 0.25 and 10% of the polymer weight.

In especially preferred embodiments of the present invention, said polyalkylene is polypropylene.

In preferred embodiments of the present said polymeric material is manufactured in the form of a short staple fiber.

In other preferred embodiments of the present invention said fiber is a continuous filament fiber.

In the most preferred embodiments of the present invention said polymeric material is manufactured in the form of a bristle and said device is a toothbrush.

In other most preferred embodiments of the present invention said polymeric material is manufactured in the form of a dental floss.

In further preferred embodiments of the present invention, said device comprises a tensioned filament of dental floss and a supporting handle therefor.

Said material can be made from almost any synthetic polymer, which will allow the introduction of an cationic, copper oxide particles into its liquid slurry state. Examples of some materials are polyetrafluoroethylene PTFE, polyurethane PR, polyalkylenes such as polypropylene and polyethylene PE, polyvinyl chloride PVC, polyester PET PDT, polyolefin, polyamides such as nylon 6, nylon 66, nylon 666, acrylic, polybutylene, PLA-2-methylaspartu/-pyridoxal-5p-phosphate, PTT, LD/HD/Linear Low Density including thermo set products, silicones. When the copper oxide dust is ground down to fine powder, e.g., a size of between 1 and 10 microns and introduced into the slurry in small quantities, e. g., in an amount of between 0.25 and 10% of the polymer weight, it was found that the subsequent product produced from this slurry exhibited antimicrobial properties.

In a further preferred embodiment of the present invention said fiber is a continuous filament fiber and in especially preferred embodiments of the present invention said continuous polymeric filament fiber is manufactured in the form of an anti-bacterial dental floss.

In other preferred embodiments of the present invention, said polymeric material is manufactured in the form of bristles for an anti-bacterial toothbrush.

The present invention also relates to the use of water insoluble copper oxide particles which release, Cu⁺⁺ ions upon contact with a fluid for the preparation of a polymeric material having microscopic water insoluble copper oxide particles which release Cu′ ions encapsulated therein with a portion of said particles being exposed and protruding from surfaces thereof for neutralizing oral bacteria.

Unlike the fibers described, e. g. in WO 98/06508 and WO 98/06509, in which the fibers are coated on the outside, in the present product the polymer has microscopic water insoluble particles of cationic copper oxide encapsulated therein with a portion of said particles being exposed and protruding from surfaces thereof. These exposed particles that protrude from the surface of the polymeric material have been shown to be active, as demonstrated by the tests set forth hereinafter.

In general, the products of the present invention are produced as follows:
1. A slurry is prepared from any polymer, the chief raw material preferably being selected from a polyamide, a polyalkylene, a polyurethane and a polyester. Combinations of more than one of said materials can also be used provided they are compatible or adjusted for compatibility. The polymeric raw materials are usually in bead form and can be mono-component, bi-component or multi-component in nature. The beads are heated to melting at a temperature that preferably will range from about 120 to 180° C.
2. At the hot mixing stage, before extrusion, a water insoluble powder of cationic copper oxide is added to the slurry and allowed to spread through the heated slurry. The particulate size will be preferably between 1 and 10 microns, however can be larger when the film or fiber thickness can accommodate larger particles.
3. The liquid slurry is then pushed with pressure through holes in a series of metal plates formed into a circle called a spinneret. As the slurry is pushed through the fine holes that are close together, they form single fibers or if allowed to contact one another, they form a film or sheath. The hot liquid fiber or film is pushed upward with cold air forming a continuous series of fibers or a circular sheet. The thickness of the fibers or sheet is controlled by the size of the holes and speed at which the slurry is pushed through the holes and upward by the cooling air flow.
4. In percentage mixtures of up to 10% by weight of cationic copper oxide dust demonstrated, no degradation of physical properties in a polyamide slurry of the finished product.

In WO 94/15463 there are described antimicrobial compositions comprising an inorganic particle with a first coating providing antimicrobial properties and a second coating providing a protective function wherein said first coating can be silver or copper or compounds of silver, copper and zinc and preferred are compounds containing silver and copper (II) oxide. Said patent, however, is based on the complicated and expensive process involving the coating of the metallic compositions with a secondary protective coating selected from silica, silicates, borosilicates, aluminosilicates, alumina, aluminum phosphate, or mixtures thereof and in fact all the claims are directed to compositions having successive coatings including silica, hydrous alumina and dioctyl azelate.

In contradistinction, the present invention is directed to the use and preparation of a polymeric material, having microscopic water insoluble particles of cationic copper oxide in powder form, which release Cu⁺⁺ upon contact with a fluid encapsulated therein with a portion of said particles being exposed and protruding from surfaces thereof, which is neither taught nor suggested by said publication and which has the advantage that the exposed Cu⁺⁺ releasing water insoluble particles which protrude from the polymeric material have been proven to be effective as antibacterial agents against oral bacteria as demonstrated in example 3 hereinafter.

In EP 427858 there is described an antibacterial composition characterized in that inorganic fine particles are coated with an antibacterial metal and/or antibacterial metal compound and said patent does not teach or suggest a polymer that incorporates microscopic water insoluble particles of cationic copper oxide in powder form, which release Cu⁺⁺ encapsulated therein with a portion of said particles being exposed and protruding from surfaces thereof.

In DE 4403016 there is described a bacteriacidal and fungicidal composition utilizing copper as opposed to ionic Cu⁺⁺ and said patent also does not teach or suggest a polymer that incorporates microscopic water insoluble particles of cationic copper oxide in powder form, which release Cu⁺⁺ encapsulated therein with a portion of said particles being exposed and protruding from surfaces thereof.

In JP-01 046465 there is described a condom releasing sterilizing ions utilizing metals selected from copper, silver, mercury and their alloys which metals have a sterilizing and sperm killing effect, wherein the metal is preferably finely powdered copper. While copper salts such as copper chloride, copper sulfate and copper nitrate are also mentioned, as is known, these are water soluble salts which will dissolve and break down the polymer in which they are introduced. Similarly, while cuprous oxide is specifically mentioned, this is a Cu⁺ ionic form, and not the Cu⁺⁺ form.

The distinction between the Cu⁺ ionic form and the Cu⁺⁺ ionic form is clear. Further, in experiments conducted on behalf of the Applicant, CuO powder (releasing Cu⁺) was not effective as an antibacterial agent against E. coli or Staphylococcus aureus bacteria while, surprisingly Cu₂O (releasing Cu⁺⁺) was effective and, surprisingly, the combination of Cu₂O and CuO was even more effective that Cu₂O by itself. The experiments used the ATCC Test Method 47, in which a zone of inhibition created around a one gram sample on a semi-wet agar is measured. Oyamada described neither the use of discreet particles of Cu₂O (releasing Cu⁺⁺) nor the use of Cu₂O and CuO in combination, as is instantly claimed and cannot anticipate the invention.

It is further to be noted that in working example 1 in table 1 of said patent, there is mentioned copper oxide although the nature of the copper oxide mentioned is not clarified. Even if one were to assume, for argument's sake, that this example refers to the use of a cupric oxide, it is to be noted that in this example, the cupric oxide is provided together with an organopolysiloxane and thus persons skilled in the art understand that this copper was cross-linked to the polymer chain and did not exist as free discreet particles.

As will therefore be realized, said patent also does not teach or suggest the use of discreet, exposed, Cu⁺⁺ releasing water insoluble particles which protrude from the polymeric material and which have been proven to be effective in the reduction of oral bacteria.

In JP-01 246204 there is described an antimicrobial molded article in which a mixture of a powdery copper compound and organic polysiloxane are dispersed into a thermoplastic molded article for the preparation of cloth, socks, etc. Said patent specifically states and teaches that metal ions cannot be introduced by themselves into a polymer molecule and requires the inclusion of organopolysiloxane which is also intended to provide a connecting path for the release of copper ions to the fiber surface.

Furthermore, also in this patent, the copper powder is introduced simultaneously with the organopolysiloxane which results in the copper being cross-linked within the polymeric material and not existing as discreet free water insoluble particles of copper oxide that protrude from the polymeric material and release Cu⁺⁺. Further, Oyamada did not describe use of a mixture of cuprous oxide and cupric oxide as instantly claimed.

Thus, as will be realized said patent does not teach or suggest the use of discreet exposed Cu⁺⁺ releasing water insoluble copper oxide particles that protrude from the polymeric material in a device for the reduction of oral bacteria.

In JP-03 113011 there is described a fiber having good antifungus and hygienic action preferably for producing underwear wherein said synthetic fiber contains copper or a copper compound in combination with germanium or a compound thereof, however, said patent teaches and requires the presence of a major portion of germanium and the copper compounds disclose therein are preferably metallic copper, cuprous iodide which is a monovalent Cu⁺ compound and water soluble copper salts. Thus, said patent does not teach or suggest the use of exposed Cu⁺⁺ releasing water insoluble copper oxide particles which protrude from the polymeric material in a device for the reduction of oral bacteria.

In EP 116865 there is described and claimed a polymer article containing zeolite particles at least part of which retain at least one metal ion having a bacterial property and thus said patent does not teach or suggest the use of exposed Cu⁺⁺ releasing water insoluble copper oxide particles, by themselves and in the absence of a zeolite, which particles protrude from the polymeric material and which have been proven to be effective in a device for the reduction of oral bacteria.

In EP 253653 there is described and claimed a polymer containing amorphous aluminosilicate particles comprising an organic polymer and amorphous aluminosilicate solid particles or amorphous aluminosilicate solid particles treated with a coating agent, at least some of said amorphous aluminosilicate solid particles holding metal ions having a bactericidal actions. Thus, said patent does not teach or suggest the use of exposed Cu⁺⁺ releasing water insoluble copper oxide particles, by themselves and in the absence of amorphous aluminosilicate particles, which exposed Cu⁺⁺ releasing water insoluble copper oxide particles, protrude from the polymeric material and which have been proven to be effective in a device for the reduction of oral bacteria.

While the invention will now be described in connection with certain preferred embodiments in the following examples and with reference to the attached figures, so that aspects thereof may be more fully understood and appreciated, it is not intended to limit the invention to these particular embodiments. On the contrary, it is intended to cover all alternatives, modifications and equivalents as may be included within the scope of the invention as defined by the appended claims. Thus, the following examples which include preferred embodiments will serve to illustrate the practice of this invention, it being understood that the particulars shown are by way of example and for purposes of illustrative discussion of preferred embodiments of the present invention only and are presented in the cause of providing what is believed to be the most useful and readily understood description of formulation procedures as well as of the principles and conceptual aspects of the invention.

### BRIEF DESCRIPTION OF THE DRAWINGS

FIG. 1 is an electron microscope photograph of a nylon fiber with copper oxide particles embedded therein and protruding therefrom after having been added to a polymeric slurry.

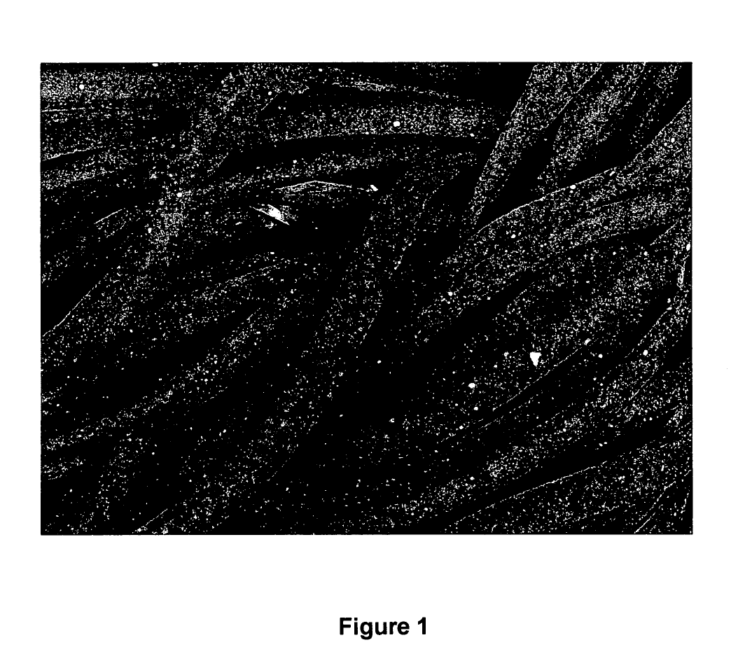

### EXAMPLE 1

### Preparation of Fibers

A total of 500 grams of a polyamide bi-component compound were prepared by heating the two beaded chemicals in separate baths each at 160° C.

The two separate components were then mixed together and allowed to stir for 15 minutes until the mixture appeared to be homogenous in color.

The mixed chemistry was again divided into two separate pots. In one pot, 25 grams of a mixture of CuO and Cu₂O powder was added yielding a 1% mixture. In the second pot 6.25 grams of a mixture of CuO and Cu₂O were added yielding a 0.25% mixture. In both cases, the temperature of 160° C. was maintained. The compounds were stirred until they appeared homogenous in color.

The two mixtures were run through a spinneret with holes that yielded fibers of between 50 and 70 microns in diameter. Since the Cu⁺⁺ releasing copper oxide powders were ground to particles of less than 20 microns no obstructions in the spinneret holes were observed. The extruded fibers were air-cooled and spun on to cones.

The fibers were tested for biological activity.

The difference between the normal process of manufacturing any synthetic fiber and this process is the addition of the Cu⁺⁺ releasing copper oxide powders in the raw materials.

### EXAMPLE 2

### Preparation of Fibers and Fabrics from Treated Polymeric Materials

A1. A polymeric material is chosen for the desired end use. Such fibers as polyetrafluoroethylene PTFE, polyurethane PR, polyalkylenes such as polypropylene and polyethylene PE, polyvinyl chloride PVC, polyester PET PDT, polyolefin, polyamides such as nylon 6, nylon 66, nylon 666, acrylic, polybutylene, PLA-2-methylaspartul-pyridoxal-5p-phosphate, PTT, LD/HD/Linear Low Density including thermo set products, silicones. etc. are among the fibers that can be used. The fiber can be formed into either a filament form or short staple form.

A2. A master batch is prepared using the same base material as the desired yarn into which a copper oxide powder is added. For most textile end uses the master batch may have a 20% -40% concentration of the copper oxide powder included in it. This master batch will be added to the polymer being extruded and diluted so that only about 1% or 2% of the material will be in the finished yarn. A certain amount of this copper will appear on the surface of a polymeric fiber and can be observed in an electron microscope picture.

A3. If the fiber is a filament fiber it can be applied to a multiplicity of uses including use as dental floss which is an extruded filament produced as an A2 from a plurality of fibers through a spinaret.

A4. For manufacturing a toothbrush, the filament is cut to the desired lengths to form such articles as brush bristles. If the diameter of the holes of the spinaret are enlarged, then there can be produced thicker polymeric filaments which can be cut to appropriate size and incorporated together with the thinner brush bristles in those toothbrushes having inner bristles and outer thicker polymeric filaments, as available on the market today.

Thus as will be realized, the difference between the normal process of manufacturing such products such as dental floss, toothbrushes and similar devices for cleaning tooth and gum surfaces, and the process of the present invention, is the addition of microscopic Cu′ releasing water insoluble particles into the polymeric raw materials.

### EXAMPLE 3

### Anti-Bacterial Testing

Bacteria were taken from the mouth cavity of two different AminoLab employees and were designated “mouth bacterial A” and “mouth bacterial B”. The bacteria were grown until a significant stock titer was achieved. Then an AATCC test method 100 was conducted using textile materials made of 100% polyester yarn prepared according to example 2 A.2, and having 1% Cu⁺⁺ releasing, discreet, water insoluble copper oxide particles incorporated therein.

Table A sets forth the results of a polyester textile fabric prepared having 1% CU⁺⁺ releasing discreet, water insoluble copper oxide particles according to the present invention and table B sets forth the control results.

TABLE A
Test results:

| Test | | Aminolab | Time 0 | | After 4 hours | |
|---|---|---|---|---|---|---|
| Microorganism | Sample ID | No. | CFU/Sample | Log | CFU/Sample | Log |
| Mouth | Textile made | M41346.04 | 3.0 × 10⁵ | 5.48 | 7.0 × 10³ | 3.85 |
| Bacterial A | from 100% | | | | | |
| | polyester | | | | | |
| | yarn having | | | | | |
| | polymeric | | | | | |
| | fibers treated | | | | | |
| | with water | | | | | |
| | insoluble | | | | | |
| | Copper oxide | | | | | |
| Mouth | Textile made | M41346.04 | 9.7 × 10⁵ | 5.99 | 6.7 × 10³ | 3.83 |
| Bacterial B | from 100% | | | | | |
| | polyester | | | | | |
| | yarn having | | | | | |
| | polymeric | | | | | |
| | fibers treated | | | | | |
| | with water | | | | | |
| | insoluble | | | | | |
| | Copper oxide | | | | | |

TABLE B
Test results:

| | | |
|---|---|---|
| Test | Time 0 | After 4 hours |

| Control | Microorganism | CFU/ml | Log | CFU/ml | Log |
|---|---|---|---|---|---|
| | Mouth Bacterial A | 2.3 × 10⁵ | 5.36 | 1.1 × 10⁶ | 6.04 |
| | Mouth Bacterial B | 2.8 × 10⁵ | 5.45 | 3.6 × 10⁶ | 6.56 |

As will be noted, a textile material made of 100% polyester yarn prepared according to the present invention and having polymeric fibers treated with water insoluble copper oxide, reduced the mouth bacterial growth A and B by 1.63 and 2.16 logs respectively after 4 hours.

As can be seen from the control, when the bacteria are not exposed to water insoluble copper oxide according to the present invention, their concentration after 4 hours is increased rather than decreased.

It will be evident to those skilled in the art that the invention is not limited to the details of the foregoing illustrative examples and that the present invention may be embodied in other specific forms without departing from the essential attributes thereof; and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

1. A device for cleaning tooth and gum surfaces said device having incorporated therein an antimicrobial polymeric material formed from a polymeric component, said material being in the form of a bristle or yarn, and comprising an antimicrobial agent consisting essentially of discreet, microscopic, Cu⁺⁺ releasing water insoluble particles, embedded directly in said component, with a portion of said particles being exposed and protruding from surfaces thereof, which particles release Cu⁺⁺ ions, upon contact with a fluid.

2. A device for cleaning tooth and gum surfaces according to claim 1, wherein said polymeric material has incorporated therein exposed Cu⁺⁺ releasing water insoluble copper oxide particles which protrude from the polymeric material.

3. A device for cleaning tooth and gum surfaces according to claim 1, wherein said polymeric material has incorporated therein a mixture of particles of CuO and Cu₂O which particles release combinations of Cu⁺⁺ and Cu⁺ upon contact with a fluid.

4. A device for cleaning tooth and gum surfaces according to claim 1, wherein said particles are of a size of between 1 and 10 microns.

5. A device for cleaning tooth and gum surfaces according to claim 1 wherein said particles are present in an amount of between 0.25 and 10% of the polymer weight.

6. A device for cleaning tooth and gum surfaces according to claim 1 wherein said polymeric component is polypropylene.

7. A device for cleaning tooth and gum surfaces according to claim 1 wherein said polymeric component is a single polymeric component.

8. A device for cleaning tooth and gum surfaces according to claim 1, wherein said polymeric material is manufactured in the form of a short staple fiber.

9. A device for cleaning tooth and gum surfaces according to claim 8 wherein said fiber is a continuous filament fiber.

10. A device for cleaning tooth and gum surfaces according to claim 1, wherein said polymeric material is manufactured in the form of a bristle.

11. A device for cleaning tooth and gum surfaces according to claim 1 wherein said polymeric material is manufactured in the form of a dental floss.

12. A device for cleaning tooth and gum surfaces according to claim 1, wherein said device is a toothbrush.

13. A device for cleaning tooth and gum surfaces according to claim 1, wherein said device comprises a tensioned filament of dental floss and a supporting handle therefor.

14. A device for cleaning tooth and gum surfaces according to claim 1, wherein said polymeric component is selected from the group consisting of a polyamide, a polyalkylene, a polyurethane and a polyester and mixtures thereof.
